(19) United States
(12) Patent Application Publication
(10) Pub. No.: US 2015/0310851 A1
(43) Pub. Date: Oct. 29, 2015

(54) Method and Apparatus for Extra-Vehicular Voice Recognition Training Including Vehicular Updating

(71) Applicant: Ford Global Technologies, LLC, Dearborn, MI (US)

(72) Inventor: Brett Stottlemyer, Southfield, MI (US)

(73) Assignee: Ford Global Technologies, LLC, Dearborn, MI (US)

(21) Appl. No.: 14/260,453

(22) Filed: Apr. 24, 2014

(51) Int. Cl. G10L 15/07; G10L 15/06

(52) U.S. Cl. CPC G10L 15/07; G10L 15/063

(57) ABSTRACT

A system includes a processor configured to communicate with an application running on an extra-vehicular device. The processor is also configured to determine if new voice-recognition improvement data exists on the device. Further, the processor is configured to download any new improvement data determined to exist on the device. Additionally, the processor is configured to store the downloaded data in a voice-recognition profile associated with a driver and utilize the downloaded data in voice-recognition when the driver attempts voice input.

### TECHNICAL FIELD

The illustrative embodiments generally relate to a method and apparatus for extra-vehicular voice recognition training including vehicular updating.

### BACKGROUND

Vehicle computing systems frequently come equipped with driver voice recognition enabled interfaces. Such interfaces allow a driver to utilize hands-free interaction with the vehicle computing system while driving, allowing the driver to focus maximum attention on the road. But, if the system is unable to recognize the driver's voice, the driver may attempt to manually correct input to the system through a vehicle interface, causing the driver to be distracted and lose focus on the road.

Voice recognition is typically a probabilistic effort whereby input speech is compared against a grammar. High quality matches are successful in resulting in the requested services, low quality matches may be rejected or misinterpreted. In general, it is difficult to custom build a new vehicle with a recognition system tailored to a specific user, so recognition algorithms may be tuned to provide good results on average, resulting in positive experiences for the maximum number of initial users. If a user has an accent, however, this process may break down or take a long time to learn the user's speech patterns through limited vehicular input.

U.S. Patent Application 2010/0185445 generally relates to a machine, system and method for user-guided teaching and modifications of voice commands and actions to be executed by a conversational learning system. The machine includes a system bus for communicating data and control signals received from the conversational learning system to a computer system, a vehicle data and control bus for connecting devices and sensors in the machine, a bridge module for connecting the vehicle data and control bus to the system bus, machine subsystems coupled to the vehicle data and control bus having a respective user interface for receiving a voice command or input signal from a user, a memory coupled to the system bus for storing action command sequences learned for a new voice command and a processing unit coupled to the system bus for automatically executing the action command sequences learned when the new voice command is spoken.

### SUMMARY

In a first illustrative embodiment, a system includes a processor configured to communicate with an application running on an extra-vehicular device. The processor is also configured to determine if new voice-recognition improvement data exists on the device. Further, the processor is configured to download any new improvement data determined to exist on the device. Additionally, the processor is configured to store the downloaded data in a voice-recognition profile associated with a driver and utilize the downloaded data in voice-recognition when the driver attempts voice input.

In a second illustrative embodiment, a computer-implemented method includes communicating with an application running on an extra-vehicular device. The method also includes determining if new voice-recognition improvement data exists on the device. Further, the method includes downloading any new improvement data determined to exist on the device. Additionally, the method includes storing the downloaded data in a voice-recognition profile associated with a driver and utilizing the downloaded data in voice-recognition when the driver attempts voice input.

In a third illustrative embodiment, a non-transitory storage medium stores instructions, which, when executed by a processor, cause the processor to perform a computer-implemented method that includes communicating with an application running on an extra-vehicular device. The method also includes determining if new voice-recognition improvement data exists on the device. Further, the method includes downloading any new improvement data determined to exist on the device. Additionally, the method includes storing the downloaded data in a voice-recognition profile associated with a driver and utilizing the downloaded data in voice-recognition when the driver attempts voice input.

### BRIEF DESCRIPTION OF THE DRAWINGS

FIG. 1 shows an illustrative vehicle computing system;

FIG. 2 shows an illustrative process for connecting to a remote vocabulary learning application;

FIG. 3 shows an illustrative process for updating an application vocabulary;

FIG. 4 shows an illustrative process for loading a vocabulary from an application;

FIG. 5 shows an illustrative process for updating an application vocabulary from a remote system; and

FIG. 6 shows an illustrative process for training vocabulary on an extra-vehicular device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

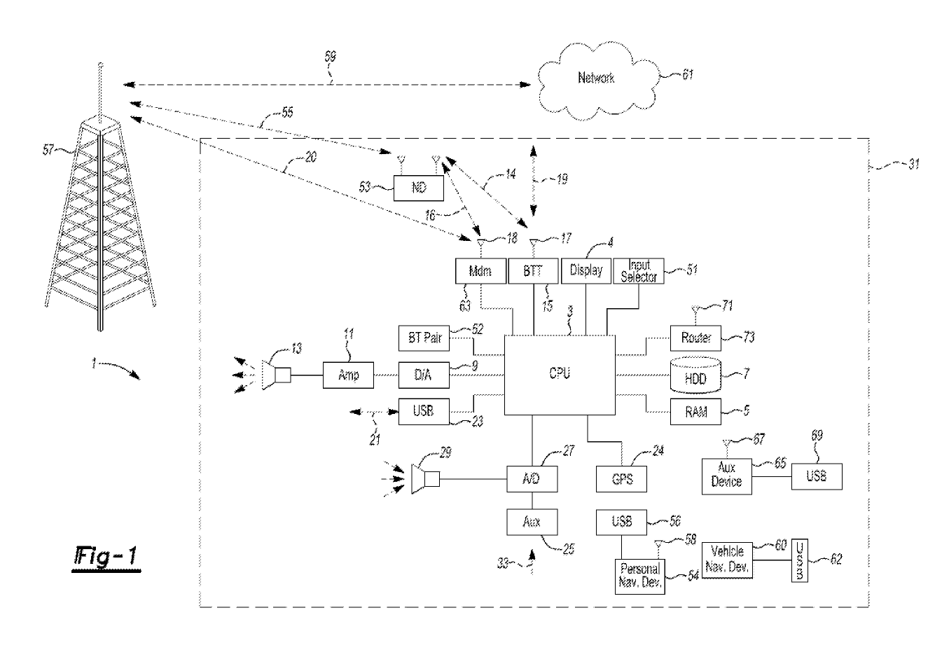

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

Speech recognition rates can be improved over time, but this typically requires some training and/or tuning data to be collected. This data could be collected in an infotainment system over time, but typical inputs to an infotainment system are limited. A user may only verbally interact with the system one or two times during a journey, or not at all, which provides a very limited sample set for updating vocabulary.

The user could also run through vocabulary enhancing exercises while in the vehicle, but this may not be something the user wishes to do while driving. In the illustrative embodiments, the user runs through recognition improvement exercises by speaking to an extra-vehicular device, from which updated recognition data can then be downloaded to the vehicle. This novel solution also allows rental cars to utilize the application to retrieve updated recognition data when the user enters the car, allowing for a more favorable voice-interaction experience with a temporary vehicle.

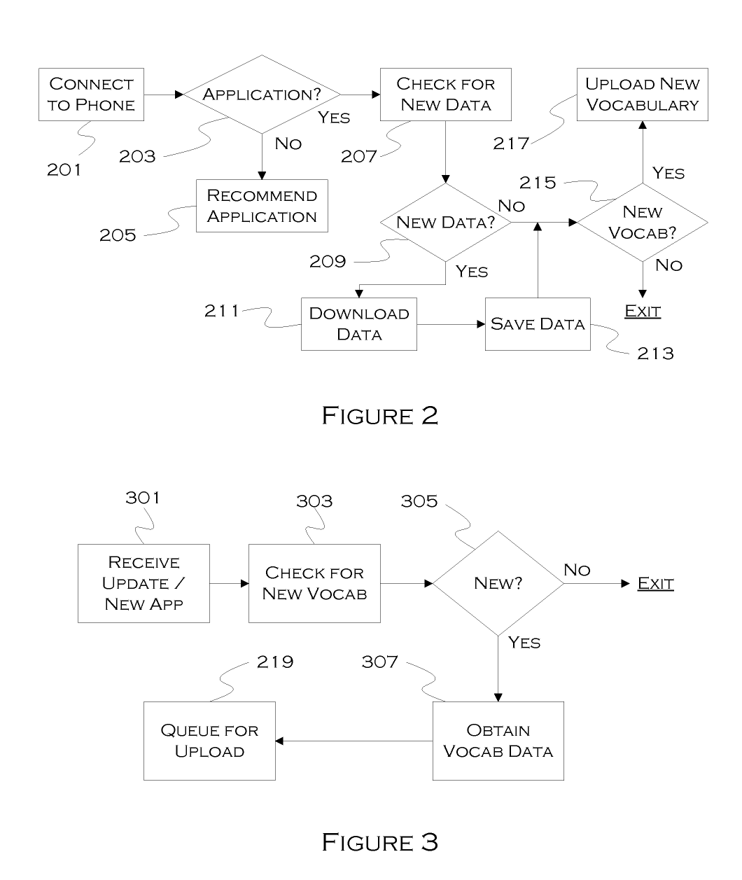

FIG. 2 shows an illustrative process for connecting to a remote vocabulary learning application. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In the illustrative examples, an extra-vehicular application is provided for learning customized recognition associated with one or more potential vehicle drivers. This could be a mobile device application, or even a personal computer application. In the illustrative embodiments, connection is described to a mobile device for obtaining application data, but the data could also be obtained from, for example, a network connection to a personal computer. The data could also be sent from the personal computer for upload to the vehicle.

Since most people spend more time out of their vehicles than in them, the application provides an opportunity for learning recognition patterns at any time that is convenient for a driver. The learning can be based on general speech recognition theory, or, in another example, could be based on first learning a list of specific commands that control the vehicle system and any applications installed thereon. Then, the user could spend additional time on generalized vocabulary learning, for using in identifying, for example, navigation or hands free calling inputs.

In the illustrative embodiment shown in FIG. 2, the vehicle connects to a phone or other mobile device 201. Upon connection, or at the request of a user, the process may check to see if the mobile vocabulary application is installed on the device 203.

If the application is not installed, the process may recommend the application to a user 205. In at least one instance, the system may wait until the user encounters some difficulty in utilizing the system before recommending the application, in case the user's speech pattern matches the predefined vocabulary.

If the application is loaded on the device, the process may check to see if any new data exists on the device 207. The data may represent information, for example, that has changed since a download of recognition information last occurred (e.g., the user has been utilizing the application since last utilizing the vehicle). Of course, if data download has never occurred, all the information may be new information. If the new data exists 209, the process may download the data 211 and save the data 213 for use by the voice recognition system.

In addition to downloading any new data, there may be new vocabulary residing on the vehicle computing system. This could relate to a software module update or, for example, a new application installed on the vehicle computing system that identifies recommended vocabulary. This vocabulary can be useful if vocabulary specific training is implemented. Even if generalized recognition training is utilized, the process may periodically check sample inputs against requisite vocabulary to see if the recognition has progressed to a suitable level.

FIG. 3 shows an illustrative process for updating an application vocabulary. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process receives a software update or a new application is installed thereon 301. Accompanying the new installation/application, the process may check to see if a new vocabulary, such as a new set of commands is included with the installed update 303. If there is any new vocabulary, the process may extract the vocabulary data 307 and store and queue the data for upload at an appropriate time 309.

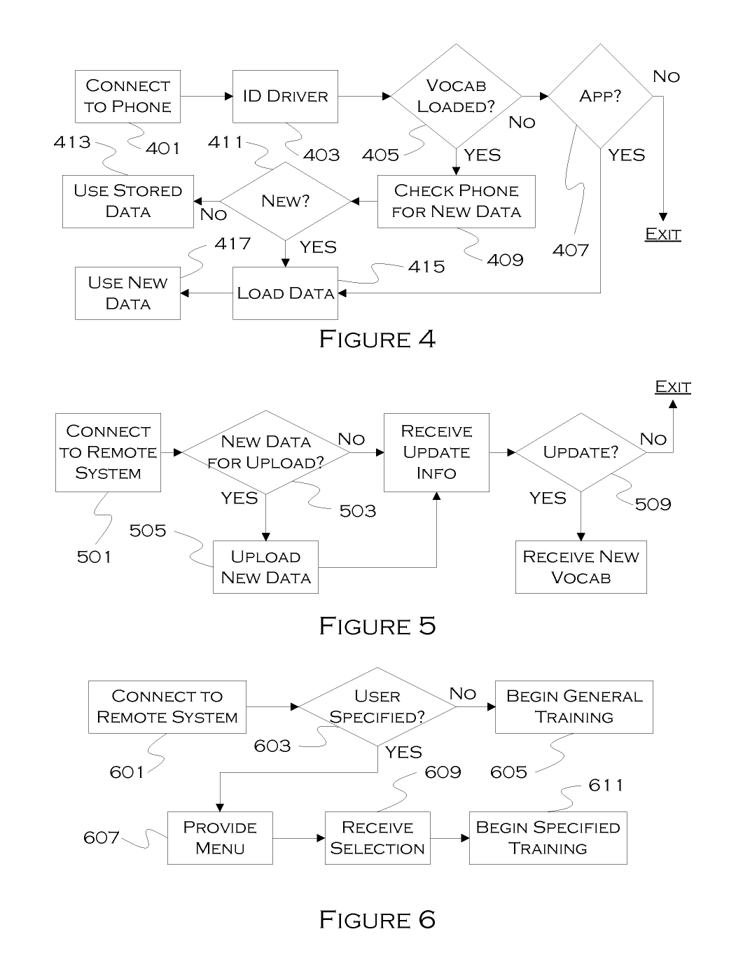

FIG. 4 shows an illustrative process for loading a vocabulary from an application. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the vehicle again connects to the mobile device 401. Information relating the device to the driver can be used to identify the driver, which can be useful in loading previously saved recognition information for that driver. The driver is identified 403 and any previously stored recognition data may be loaded for that driver.

If a vocabulary/recognition data is loaded 405, the process may check the device for new data 409. If new data does not exist 411, the process may use the previously stored data 413. If new data exists, however, the process may download the new data from the device and update the stored data with the new data. The updated recognition data may then be used by the process 417.

Even if no vocabulary is loaded, the process may check to see if the application exists on the device. If the application exists 407, the processor loads any data that exists on the device, associated with the application. This data may then be used for voice recognition and stored for later use. If there is no data on the device, or if the application is not loaded, the process may instruct the vehicle computer to use the standard data included with the vehicle.

FIG. 5 shows an illustrative process for updating an application vocabulary from a remote system. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In the illustrative example shown in FIG. 5, the process running on the extra-vehicular device connects to a remote system 501. The remote system may be a vehicle computer, or the system may be a remote server that recognizes an update to the vehicle. For example, in one instance, an update to a vehicle, or an addition of a new application, may result in an update to a vehicle configuration file on a remote server that tracks the state of the vehicle's software system. This data can be used to update the device, even if the device is not connected to the vehicle directly. The update to the configuration file may include an upload of any vocabulary associated with the software update(s).

Once the process has connected to a remote system, the process will check to see if any new recognition data exists on the phone for upload to the vehicle/remote system 503. In one embodiment, the data may be uploaded directly to a vehicle. In another illustrative example, the data may be uploaded to a remote computing system, which can be accessed by a plurality of different vehicles, even if the mobile device containing the application is not present in the vehicle. This can be useful, for example, if a user switches mobile devices and the new device does not contain the application or any of the data resulting from using the application.

If there is new data for upload (e.g., the application has been used to train recognition), the process may upload the new data to the remote device 505. If there is no new data, the process may receive any information relating to updates of the application 507. This can include, but is not limited to, updates to the vocabulary.

If there is an update available on the connected remote system 509, the process may download the updated vocabulary (if it exists) 511 from the remote system and update the application with the new vocabulary.

FIG. 6 shows an illustrative process for training vocabulary on an extra-vehicular device. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process running on the extra-vehicular device is launched and training is initiated 601. The user may be able to specify certain training, or training may be specified for a user based on commonly used vehicle features. If there is training specified 603, the process may provide a menu corresponding to available training options or recommendations.

For example, if a user typically uses phone services and navigation services, the process may recommend training oriented on these functions. Or, a user may request a list of all options, and a menu may show the available options for training.

Once the menu is provided 607, the process may receive selection of a training option 609. The specified training may then begin 611. In an example where a vehicle system determines which training is appropriate, the process may skip the menu and selection step and present the most appropriate user training based on commonly used features. In yet another example, the process may train “required” vocabulary (i.e., fixed commands) until the recognition rate is suitable, and may then permit general training. In this example, if no training is specified, general recognition training may begin, using known recognition training techniques.

In at least one embodiment, the vehicle computer may keep a record of commonly used input attempts that a specific driver has attempted. Successes and failures may or may not also be identified and associated with this record. Upon receiving an update request from the extra-vehicular device, the processor may upload data relating to the commonly used input attempts and may instruct the application to train recognition relating to these events, such that recognition relating to commonly requested events is more rapidly improved.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
communicate with an application running on an extra-vehicular device;
determine if new voice-recognition improvement data exists on the device;
download any new improvement data determined to exist on the device;
store the downloaded data in a voice-recognition profile associated with a driver; and
utilize the downloaded data to improve voice-recognition when the driver attempts voice input.

2. The system of claim 1, wherein the processor is configured to identify the driver based on the device and wherein the voice-recognition profile is associated with the identified driver.

3. The system of claim 1, wherein the processor is further configured to receive new vocabulary data, associated with a software update, and to upload the new vocabulary data to the device.

4. The system of claim 1, wherein the processor is further configured to receive new vocabulary data, associated with a new application, and to upload the new vocabulary data to the device.

5. The system of claim 1, wherein the processor is further configured to: instruct the device as to commonly used vehicular input attempts and instruct the device to train recognition related to the commonly used vehicular input attempts.

6. The system of claim 1, wherein the processor is configured to, when storing the downloaded data, update an already-existing recognition profile, having recognition data stored therein, the update based on the downloaded data.

7. The system of claim 1, wherein the extra-vehicular device includes a mobile device.

8. A computer-implemented method comprising:
communicating with an application running on an extra-vehicular device;
determining if new voice-recognition improvement data exists on the device;
downloading any new improvement data determined to exist on the device;
storing the downloaded data in a voice-recognition profile associated with a driver; and
utilizing the downloaded data to improve voice-recognition when the driver attempts voice input.

9. The method of claim 8, further including identifying the driver based on the device and wherein the voice-recognition profile is associated with the identified driver.

10. The method of claim 8, further including receiving new vocabulary data, associated with a software update, and to upload the new vocabulary data to the device.

11. The method of claim 8, further including receiving new vocabulary data, associated with a new application, and to upload the new vocabulary data to the device.

12. The method of claim 8, further including: instructing the device as to commonly used vehicular input attempts and instructing the device to train recognition related to the commonly used vehicular input attempts.

13. The method of claim 8, further including, when storing the downloaded data, updating an already-existing recognition profile, having recognition data stored therein, the update based on the downloaded data.

14. The method of claim 8, wherein the extra-vehicular device includes a mobile device.

15. A non-transitory storage medium, storing instructions, which, when executed by a processor, cause the processor to perform a computer-implemented method comprising:
communicating with an application running on an extra-vehicular device;
determining if new voice-recognition improvement data exists on the device;
downloading any new improvement data determined to exist on the device;
storing the downloaded data in a voice-recognition profile associated with a driver; and
utilizing the downloaded data to improve voice-recognition when the driver attempts voice input.

16. The storage medium of claim 15, the method further including identifying the driver based on the device and wherein the voice-recognition profile is associated with the identified driver.

17. The storage medium of claim 15, the method further including receiving new vocabulary data, associated with a software update, and to upload the new vocabulary data to the device.

18. The storage medium of claim 15, the method further including receiving new vocabulary data, associated with a new application, and to upload the new vocabulary data to the device.

19. The storage medium of claim 15, the method further including: instructing the device as to commonly used vehicular input attempts and instructing the device to train recognition related to the commonly used vehicular input attempts.

20. The storage medium of claim 15, the method further including, when storing the downloaded data, updating an already-existing recognition profile, having recognition data stored therein, the update based on the downloaded data.
